(19) United States
(12) Patent Application Publication
(10) Pub. No.: US 2006/0065019 A1
(43) Pub. Date: Mar. 30, 2006

(54) Method for floating glasses on bismuth-containing media

(76) Inventors: Uwe Kolberg, Mainz (DE); Holger Kasprzik, Mainz (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/209,047

(22) Filed: Aug. 23, 2005

(30) Foreign Application Priority Data
Aug. 23, 2004 (DE) 102004040842.4-45

(51) Int. Cl. C03B 18/18; C03C 3/16

(52) U.S. Cl. 65/99.4; 501/45; 65/99.2

(57) ABSTRACT

The present invention refers to a new method for floating glasses which are susceptible to reduction reactions, in particular phosphate-containing glasses, with float media which comprise bismuth and/or lead as one basic ingredient. This method can solve the problem that glasses which are susceptible to reduction reactions become useless in conventional, tin-containing float media. Due to this fact, till now no float method for such glasses existed. Rather, from them was produced rolled glass and the required surface quality was effected through expensive and costly grinding and polishing.

### FIELD OF THE INVENTION

The present invention relates to a new method for floating glasses which are susceptible to reduction reactions, such as for example phosphate-containing glasses with float media which contain bismuth and/or lead as one basic ingredient.

### BACKGROUND OF THE INVENTION

The float process for glasses has been known for a long time. Generally, as a float medium metallic tin is used. Here it is advantageous that this element has a low melting point which is below the T_{G} of most glasses. Furthermore the boiling point is high, namely above V_{A} of most glasses so that a broad temperature range from cast viscosity to solid glass is available for conducting the glass forming process. Furthermore, the element is cheap and regarding its redox behaviour it is basically advantageous.

Nevertheless there are uses for which tin is useless as float medium. This is in particular the case with floating of glasses having ingredients which are reducible in a relatively easy way and which here are referred to as “susceptible to reduction reactions”. For this invention, the term “susceptible to reduction reactions” should mean that ingredients are present in the respective glass which are reduced by tin as float medium during a float process. Besides glasses which contain conventional fining agents, these are for example phosphate glasses in which during floating with tin the element phosphorus which is pentavalent in the glass is reduced to oxidation state 3 or even lower, resulting in glass which is useless after floating. Also other glasses than one on phosphate basis, namely ones which contain for example other polyvalent oxides which are susceptible to reduction reactions cannot be floated by means of tin as float medium due to undesired redox reactions. Such glasses are for example coloured glasses, wherein the polyvalent oxides which are susceptible to reduction reactions are used as dyes and impart a respective colour to the glass.

### RELATED ART

According to Proc. Roy. Soc. Lond. A. 314, 1-25 (1969), a review about the method of floating glasses (“the float glass process”), a conventional float process with soda-lime glass in the range of middle temperatures (600-1100° C.) is described and an evaluation of non-reducible glasses is made. According to this literature, suitable float media are the known tin and in addition gallium and indium. Bismuth is mentioned as being not suitable.

U.S. Pat. No. 6,482,758 suggests to use besides the known tin also gold as a medium for floating extremely high melting glasses. According to U.S. Pat. No. 6,065,309, also gold, silver, copper and silicon, germanium and tin, as well as eutectic mixtures are suggested as float media for glasses. U.S. Pat. No. 6,532,772 discloses the elements Ga, Sn and Al as “float medium”, wherein the patent document substantially relates to the combining of a microelectronic semiconductive substrate. In U.S. Pat. No. 4,406,682 is described, how the precipitate of sulfides (SnS, SnS₂) on the ribbon of glass can be reduced by the addition of low amounts of Cu to a Sn-float bath.

However, a disadvantage of the float media known according to prior art is that for glasses which are susceptible to reduction reactions, such as for example phosphate-containing glasses or also coloured glasses, none of the media is practicable and economical at the same time. If expensive media such as media of silver or gold would be used for solving the problem of undesired reduction, here problems would be expected concerning the temperatures which would then be necessary during the float process and in addition such methods could not be economical. As mentioned above, glasses which are susceptible to reduction reactions contain components which render the glass useless in floating with conventional tin media through undesired reduction reactions.

Since for such glasses no float process is available according to prior art, for those generally rolled glass is produced and the required surface quality is effected through expensive grinding and polishing which causes considerable costs and effort in comparison to a float process.

### SUMMARY OF THE INVENTION

Accordingly, a considerable need exists for providing a float process also for glasses which are susceptible to reduction reactions, such as for example for phosphate glasses or optical coloured glasses on the basis of phosphate.

Surprisingly it has been shown that the use of bismuth and/or lead in float media allows also the processing of glasses which are susceptible to reduction reactions through float processes. Here it should be mentioned that lead satisfies the requirements so that it is applicable in the sense of the present invention, but from ecological point of views its use may however not be recommendable.

Accordingly the present invention provides a method for floating glasses which are susceptible to reduction reactions, such as described in the patent claims.

According to the method of the present invention, bismuth is present in the float medium in such amounts that undesired reduction reactions can be avoided. Preferable, the amount of bismuth in the float medium is higher than 50 mole %, further preferable higher than 80 mole %. According to further preferable embodiments, the amount of bismuth is higher than 90 mole %, preferable higher than 95 mole %, further preferable higher than 98 mole % and optionally even 100 mole %. This is also the case for the use of lead, if a method according to this embodiment is carried out.

Elements such as copper, silver and gold (Cu, Ag, Au) may be contained in the float medium in small amounts, if necessary in modified form which is suitable through the addition of low amounts of alloys. Here it has to be considered that the liquidus temperature is not higher than 500° C. and preferable is between 200° C. and 500° C. Here as liquidus temperature the temperature should be meant at which the float bath is completely in liquid form and thus no solid phases are present. The person skilled in the art will select amounts of other elements which may be present in the float medium, such as for example germanium and zinc, so that the mentioned liquidus temperature will not be exceeded. This is also the case for the elements tin and lead, wherein with the optional presence of tin, zinc and/or germanium in the float medium it has to be considered that the contained amount does not result in said undesired reduction reactions.

As described above, the float medium may mainly consist of bismuth, wherein advantageously due to the difference of the densities of bismuth and the conventionally used tin (it is about 25%) the depth of the bath can be reduced in the same order, whereby thus less bismuth (in comparison to tin) can be used as a float medium during the float process.

Glasses which are susceptible to reduction reactions and which can be processed by the new float method are in particular phosphate-containing glasses. They contain P₂O₅ as one basic ingredient of the glass-forming substances present in the glass. Preferable, the group of glass-forming substances in the phosphate-containing glass consists of P₂O₅ in an amount of higher than 90 mole %.

Suitable containers for the float process may for example consist of graphite, quartz glass, iron or special steels.

The float method is preferably carried out under protective gas (for example inert gas, consisting of 90% of N₂ and 10% of H₂). According to the method, the person skilled in the art will select a suitable composition of the inert gas. A suitable temperature for melting a float medium which mainly consists of bismuth is for example 350° C. Optimum melting results can be achieved in a short time, when the float medium which consists of bismuth under inert gas is first heated to ca. 850° C. and then cooled to the target temperature. As explained, the liquidus temperature of the float medium should not be higher than 500° C.

### BRIEF DESCRIPTION OF THE DRAWINGS

FIG. 1 shows a casting which was prepared from example glass 1 in a graphite crucible, wherein a small part of the glass has been removed which renders the tin visible which is placed below that and which was used as a float medium. Massive staining and a strong formation of bubbles can be clearly seen. The glass is of sponge-like consistence. Accordingly, tin is not suitable as a float medium.

FIG. 2 shows an experimental set-up for floating with bismuth-containing media.

FIG. 3 shows a casting which was prepared from example glass 1 in a graphite crucible and which does not even show a grey hue inside the cracks. The casting has been prepared according to example 5.

FIG. 4 shows the transmission measurement of the sample obtained from example 6.

FIG. 5 shows a transmission sample of coloured glass which has been prepared according to example 7. No bubbles or strias can be seen.

FIG. 6 shows the transmission measurement of the sample obtained from example 7.

The following embodiment examples describe the present invention, however without limiting its scope of protection:

### DETAILED DESCRIPTION OF THE PREFERRED EMBODIMENTS

### EXAMPLE 1

For floating in bismuth, a hole having a diameter of 10 mm was drilled into the bottom plate of an annealing oven. Through the opening a Pt-inlet pipe øa=6.5 mm; øi=4 mm was introduced and the oven chamber was continuously purged with protective gas (inert gas 80% of N₂; 20% of H₂). The rate-of-flow was about 1.5 l/min. After the purging of the oven camber for about one hour, it was tempered to 850° C.

Then a graphite container which was filled with about 1000 g of bi-granules was placed in the oven.

As glass the phosphate glass example glass 1 without dyes (CuO, CeO₂) was used.

The glass is a “low-T_{g}-glass” (T_{g}<300° C.). The following tables show more detailed data of the alkali phosphate glass which is referred to as example glass 1.

TABLE 1
Composition of example glass 1, with and without copper
oxide/cerium oxide:

| Example glass 1 | | | |
|---|---|---|---|
| Synthesis in | | without CuO/ | |
| % by weight | with CuO | without CeO | Raw material |
| B₂O₃ | 1.15 | 1.18 | H₃BO₃ |
| Na₂O | 4.68 | 4.82 | NaPO₃ |
| K₂O | 4.84 | 4.98 | K₂CO₃ |
| BaO | 5.80 | 5.97 | Ba(H₂PO₄)₂ |
| CaO | 0.66 | 0.68 | Ca(PO₃)₂ |
| ZnO | 0.27 | 0.27 | ZnO |
| Al₂O₃ | 4.37 | 4.50 | Al(PO₃)₃ |
| As₂O₃ | 0.18 | 0.18 | As₂O₃ |
| CeO₂ | 0.35 | 0.36 | CeO₂ |
| Li₂O | 4.68 | 4.82 | Li₂CO₃ |
| P₂O₅ | 68.58 | 70.63 | P₂O₅ |
| Cl | 0.30 | 0.30 | KCl |
| F | 1.25 | 1.29 | KHF₂ |
| CuO | 2.91 | | CuO |
| Σ | 100.02 | 100.00 | |

TABLE 4.2
Physical properties of example glass 1

| | Example glass | Example glass 1 |
|---|---|---|
| Measurements | 1 with CuO | without CuO |
| ρin g/cm³ | 2.67 | 2.61 |
| α_{20-200° C.} in 10⁻⁶/K | 13.81 | 14.6 |
| T_{g} in ° C. | 307 | 289 |
| V_{A} in ° C. | | 525 |
| EW | | 419 |
| n_{d} | 1.5280 | 1.51858 |
| υ_{d} | | 68.16 |
| OEG (495-1025° C.) | | no def. |
| | | devitrification |

In the oven through which protective gas was passed, the glass was cast on a float bath of bismuth which was in a graphite crucible. With a suitable temperature run a colourless glass without bubbles and without the phenomenon of crystallisation was obtained. The temperature was a little bit higher than the temperature which was estimated due to the viscosity data of the float tanks.

### COMPARATIVE EXAMPLE

An experiment which was carried out for comparative purposes and during which the glass mentioned in example 1 was cast onto tin as float medium at the same temperature showed an unacceptable result: The material obtained was a sponge-like conglomerate of bubbles and glass with an intensive dirty grey-black staining.

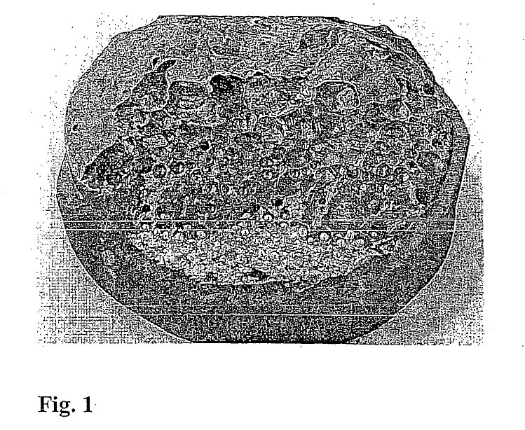

Presumably, with the use of tin the reaction Sn+P₂O₅→SnO₂+P₂O₃ takes place, wherein P₂O₃ evaporates and partially disproportionates again to elementary phosphorus and P₂O₅. Phosphorus causes the unacceptable black staining and the bubbles, as can be seen from FIG. 1.

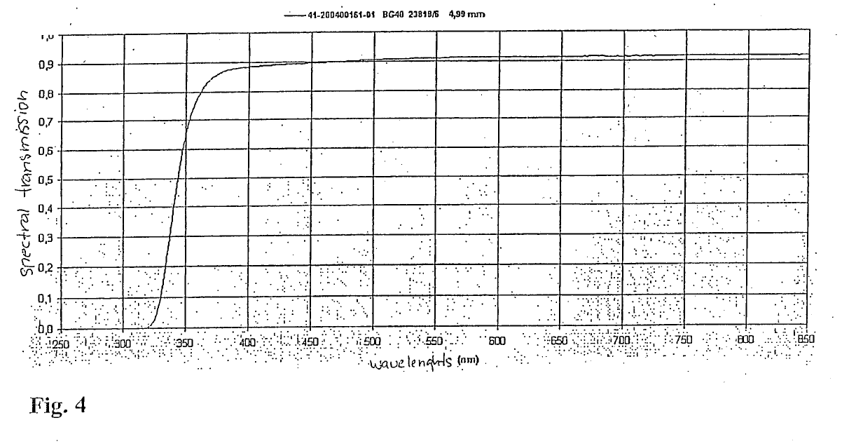

However, bismuth is—in contrast to tin—suitable as a float medium for phosphate glasses which are susceptible to reduction reactions, since no redox processes between glass and metal take place which can be seen from the excellent result shown in FIG. 4. For the experiment which gives the advantageous result see the description in the examples 5 and 6 below.

### EXAMPLE 2

According to the experimental set-up described in example 1, a float bath of bismuth was heated to 820° C. under an atmosphere of protective gas and cooled to 500° C. Then the example glass 1 was cast (T=800° C.).

After cooling, the glass was examined: Its thickness was about 4 mm, it was free of bubbles and colourless.

### EXAMPLE 3

In an analogous experimental set-up as described in example 2 the example glass 1 was cast at a float bath temperature of 650° C. In addition, the Pt-inlet pipe has been bended so that the protective gas is exactly directed onto the Bi-surface. In addition, the graphite container was covered with a lid of silicon carbide.

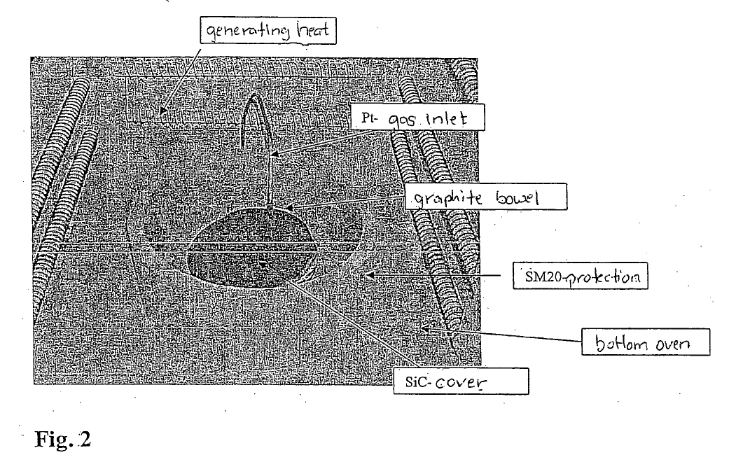

FIG. 2 shows this experimental set-up in an exemplary way.

In this case, inert gas consisting of 90% of N₂ and 10% of H₂ was used as a protective gas. The rate-of-flow has been reduced (7 Skt. ca. 0.6 to 0.8 l/min), since the form was covered with the SiC-lid.

### EXAMPLE 4

The experimental set-up corresponded to that of example 3. The float bath temperature (600° C.) and the cast temperature (600° C.) have been modified. In the oven the graphite crucible has been placed a little bit higher, whereby the height of fall of the glass during casting has been reduced. The grey hue of the glass disappeared in the volume. Only at the lower side of the glass metallic Bi adhered, wherein this layer could be polished off without any problem. After that, the glass was clear and no bubbles could be seen.

A transmission spectrum could be measured. With this, no wavelength-dependent transmission lowering could be observed. Together with the absence of bubbles from this can be concluded that a reactive interaction between the glass and the float medium has not taken place.

### EXAMPLE 5

The course of the above experiments was maintained, but now the float bath and casting temperature was lowered to 570° C.

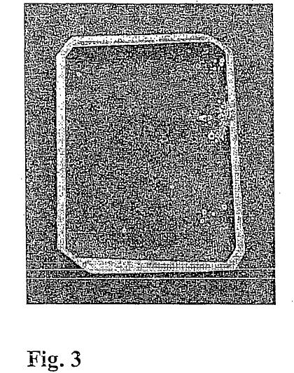

The result of the experiment was satisfactory and in part even better than in example 4. No grey staining occurred and no residual strias of bismuth could be seen, as shown in FIG. 3.

### EXAMPLE 6

The conditions of the experiment were identical to those of example 5, however a fresh glass melt which was prepared of a mixture was used for minimizing the yellow hue through Pt. In a transmission measurement, the casting so prepared has not shown a shift of the blue cutoff through solved Pt-oxide. The transmission can be seen in FIG. 4.

### EXAMPLE 7

In this experiment a coloured glass containing the dyes CuO and CeO₂ was used. The course of the above experiment which is described in example 5 was maintained.

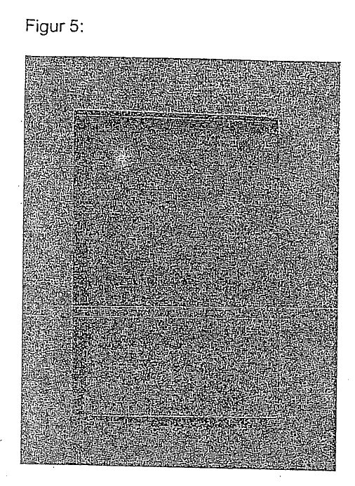

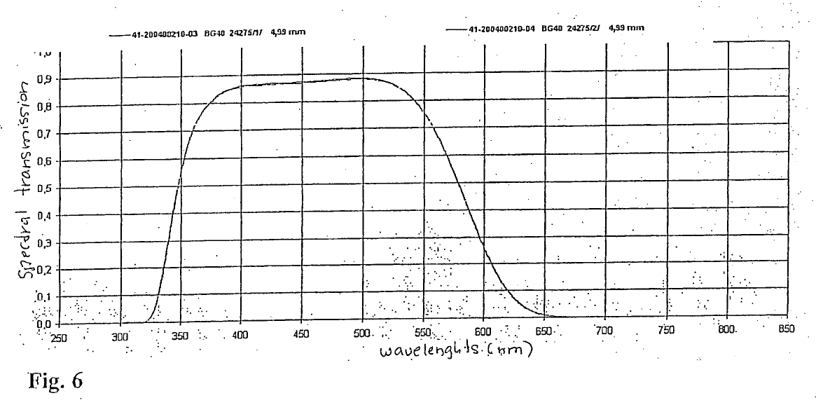

The result is satisfactory, as it also was in the experiments with glasses without colouring which also can be seen in FIG. 5: There are no bubbles and no staining. The corresponding transmission spectrum is shown in FIG. 6.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding German application No. 104040847.4, filed Aug. 23, 2004 are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What we claim is:

1. A method for floating glasses which are susceptible to reduction reactions, characterized in that the float medium contains bismuth and/or lead in an amount which is suitable for preventing undesired reduction reactions and which further allows a maximum liquidus temperature of the float bath of 500° C.

2. A method for floating glasses which are susceptible to reduction reactions, characterized in that the float medium contains bismuth and/or lead in an amount of at least 50 mole % for preventing undesired reduction reactions and which further allows a maximum liquidus temperature of the float bath of 500° C.

3. The method according to claim 1, wherein the float medium contains bismuth and/or lead in an amount of at least 50 mole %.

4. The method according to claim 1, wherein the float medium does not contain lead.

5. The method according to claim 1, wherein the glass contains phosphate.

6. The method according to claim 5, wherein more than 90 mole % of the glass-forming substances consist of P₂O₅.

7. The method according to claim 1, wherein in the glass as colorant oxidic components are present.

8. The method according to claim 1, wherein besides bismuth and/or lead the float medium also contains up to a maximum of 10 mole % of one or more of the elements Cu, Ag, Au, Ge, Sn or Zn.

9. Use of bismuth and/or lead for floating glass which is susceptible to reduction reactions.
